(19) United States
(12) Patent Application Publication
(10) Pub. No.: US 2021/0173177 A1
(43) Pub. Date: Jun. 10, 2021

(54) MAGNETIC MIRROR MOVEMENT

(71) Applicant: Panasonic Automotive Systems Company of America, Division of Panasonic Corporation of North America, Peachtree City, GA (US)

(72) Inventors: EDO OMANOVIC, LIVONIA, MI (US); PATRICK O'CONNELL, NOVI, MI (US)

(73) Assignee: Panasonic Automotive Systems Company of America, Division of Panasonic Corporation of North America

(21) Appl. No.: 16/950,054

(22) Filed: Nov. 17, 2020

Related U.S. Application Data
(60) Provisional application No. 62/943,849, filed on Dec. 5, 2019.

(51) Int. Cl. G02B 7/182; G02B 5/10; G02B 27/01; G02B 26/10; G02B 26/08

(52) U.S. Cl. CPC G02B 7/1821; G02B 5/10; G02B 27/0101; B60K 35/00; G02B 26/0816; B60K 2370/1529; G02B 26/10

(57) ABSTRACT

A mirror arrangement includes a mirror that is rotatable about an axis. A mirror magnet is attached to the mirror. A plurality of electro-magnets are positioned relative to the mirror magnet such that the electro-magnets can be individually activated to thereby attract or repel the mirror magnet and thereby cause rotation of the mirror about the axis.

### CROSS-REFERENCED TO RELATED APPLICATIONS

This application claims benefit of U.S. Provisional Application No. 62/943,849 filed on Dec. 5, 2019, the disclosure of which is hereby incorporated by reference in its entirety for all purposes.

### BACKGROUND OF THE INVENTION

### 1. Field of the Invention

The present invention relates to a system for moving a mirror in a head up display of a motor vehicle.

### 2. Description of the Related Art

A head up display emits light that reflects from the front windshield to be seen by the driver. The light appears to come from a virtual image in front of the driver and in front of the windshield. This type of head up display is currently commercially available.

Conventional head up displays create the virtual image by first using a display to create an image. Next, the light from the image is reflected from one or more mirrors. Next, the light from the mirrors is directed up to the windshield and is then reflected from the windshield towards the driver. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

Currently, all head up displays include a stepper motor as the movement mechanism, and there are no alternate ways of moving the mirrors inside of head up displays.

### SUMMARY OF THE INVENTION

The invention may be a replacement for current mirror movement mechanisms in head up displays or other applications using a stepper motor. By use of electromagnets wired in such a way that each can be controlled individually, the position of the movable mirror inside of a head up display may be controlled.

The invention may reduce the size of a head up display (HUD). The inventive mirror movement mechanism may enable a reduction in the horizontal size of the HUD and enable the head up display to fit into many more vehicles that have tight packaging restrictions.

In addition to size reduction, the inventive method may enable completely quiet operation and may reduce all audible noise created by stepper motor operation. To the end user/driver of the vehicle, the mirror movement may be completely silent.

The invention comprises, in one form thereof, a mirror arrangement including a mirror that is rotatable about an axis. A mirror magnet is attached to the mirror. A plurality of electro-magnets are positioned relative to the mirror magnet such that the electro-magnets can be individually activated to thereby attract or repel the mirror magnet and thereby cause rotation of the mirror about the axis.

The invention comprises, in another form thereof, a method for positioning a mirror of a head up display in a motor vehicle. The method includes attaching a mirror magnet to the mirror. A plurality of electro-magnets are positioned in association with the mirror magnet. At least one of the electro-magnets is individually activated to thereby attract or repel the mirror magnet and thereby cause rotation of the mirror about an axis.

The invention comprises, in yet another form thereof, a mirror arrangement including a mirror that is rotatable about an axis. A mirror magnet is attached to the mirror. A plurality of electro-magnets are positioned in an arcuate pattern such that the electro-magnets can be individually activated to thereby attract or repel the mirror magnet and thereby cause rotation of the mirror about the axis.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic perspective view of a magnetic tab and mirror of one embodiment of a mirror arrangement of the present invention.

FIG. 2 is a schematic side view of the mirror arrangement of FIG. 1 along line 2-2 of FIG. 1.

FIG. 3 is a flow chart of one embodiment of a method of the present invention for positioning a mirror of a head up display in a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

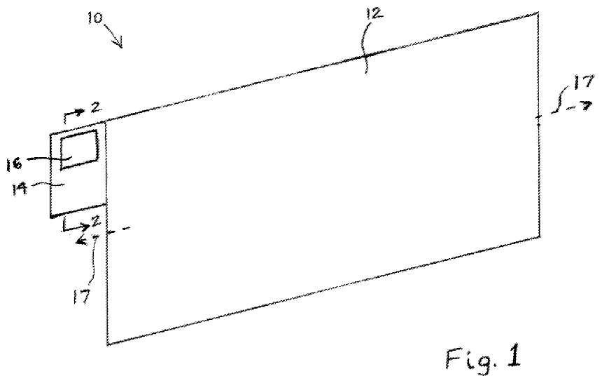

FIG. 1 illustrates one embodiment of a mirror arrangement 10 of the present invention including an aspheric mirror 12 having a magnetic tab 14 attached thereto. Aspheric mirror 12 may be a movable mirror inside of the HUD unit. Magnetic tab 14 may house a mirror magnet 16. Magnetic tab 14 can be a separate component from mirror 12. Alternatively, magnetic tab 14 can be molded from the same tool as mirror 12, with magnet 16 being later inserted into tab 14. Mirror 12 may be rotatable about an axis 17.

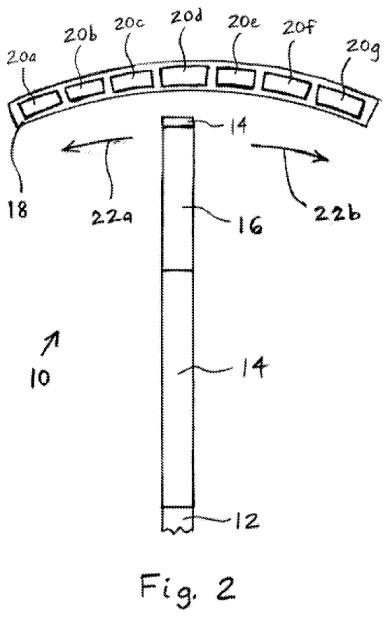

A magnet chain 18 (FIG. 2) includes many electro-magnets 20a-g in close proximity to magnetic tab 14. Electro-magnets 20a-g may be arranged concentricly about axis 17.

Each of electro-magnets 20a-g is capable of attracting magnetic tab 14 when the electro-magnet is electrically activated or energized so as to be magnetic. Each electro-magnet 20a-g in magnet chain 18 can be controlled and activated individually to attract magnetic tab 14 closer to the activated one of electro-magnets 20a-g. By precisely controlling which of electro-magnets 20a-g is activated, the position of magnetic tab 14 may be reliably and accurately adjusted either in the direction of arrow 22a or in the direction of arrow 22b, which in turn moves the entire aspheric mirror 12 about axis 17.

Magnet chain 18 may be a molded piece of plastic which houses many electro-magnets. The magnet chain molding may follow the curvature of the movement of the mirror, so magnet chain 18a may define a radius having axis 17 at, and coincident with, the origin or end of the radius. Thus, the length of the radius depends on various factors of the optical design (e.g., mirror position, mirror size, axis of rotation).

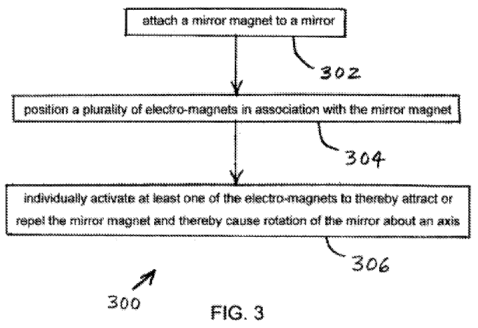

FIG. 3 illustrates one embodiment of a method 300 of the present invention for positioning a mirror of a head up display in a motor vehicle. In a first step 302, a mirror magnet is attached to a mirror. For example, mirror magnet 16 may be attached to mirror 12 through magnetic tab 14.

In a next step 304, a plurality of electro-magnets are positioned in association with the mirror magnet. For example, chain 18 of electro-magnets 20a-g may be placed close enough to magnet 16 that electro-magnets 20a-g may attract and/or repel magnet 16. Chain 18 may be shaped to be concentric about mirror axis of rotation 17. However, it is also possible for chain 18 to be linearly-shaped or to have many other possible shapes so long as each of electro-magnets 20a-g is disposed at a different respective distance and/or direction from magnet 16.

In a final step 306, at least one of the electro-magnets is individually activated to thereby attract or repel the mirror magnet and thereby cause rotation of the mirror about an axis. For example, in the positions shown in FIG. 2, electro-magnet 20a may be activated to attract magnet 16 and thereby cause rotation of mirror 12 in direction 22a about axis 17.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A mirror arrangement comprising:
a mirror that is rotatable about an axis;
a mirror magnet that is attached to the mirror; and
a plurality of electro-magnets positioned relative to the mirror magnet such that the electro-magnets can be individually activated to thereby attract or repel the mirror magnet and thereby cause rotation of the mirror about the axis.

2. The arrangement of claim 1, wherein the mirror comprises an aspheric mirror of a head up display in a motor vehicle.

3. The arrangement of claim 1, wherein the electro-magnets are positioned relative to the mirror magnet such that the electro-magnets can be individually activated to thereby attract the mirror magnet and thereby cause rotation of the mirror about the axis.

4. The arrangement of claim 1, wherein the electro-magnets can be individually activated by applying a respective voltage to each said electro-magnet.

5. The arrangement of claim 1, wherein the electro-magnets are positioned along an imaginary arc.

6. The arrangement of claim 5, wherein the imaginary arc defines a radius having the axis at an origin of the radius.

7. The arrangement of claim 1, wherein the mirror magnet is attached to a longitudinal end of the mirror.

8. A method for positioning a mirror of a head up display in a motor vehicle, the method comprising:
attaching a mirror magnet to the mirror;
positioning a plurality of electro-magnets in association with the mirror magnet; and
individually activating at least one of the electro-magnets to thereby attract or repel the mirror magnet and thereby cause rotation of the mirror about an axis.

9. The method of claim 8 wherein the mirror comprises an aspheric mirror.

10. The method of claim 8, wherein the electro-magnets are positioned relative to the mirror magnet such that the electro-magnets can be individually activated to thereby attract the mirror magnet to the activated magnet and thereby cause rotation of the mirror about the axis.

11. The method of claim 8, wherein the electro-magnets are individually activated by applying a respective voltage to each said electro-magnet.

12. The method of claim 8, wherein the electro-magnets are positioned along an imaginary arc.

13. The method of claim 12, wherein the imaginary arc defines a radius having an origin at the axis.

14. The method of claim 8, wherein the mirror magnet is attached to a longitudinal end of the mirror.

15. A mirror arrangement comprising:
a mirror that is rotatable about an axis;
a mirror magnet that is attached to the mirror; and
a plurality of electro-magnets positioned in an arcuate pattern such that the electro-magnets can be individually activated to thereby attract or repel the mirror magnet and thereby cause rotation of the mirror about the axis.

16. The arrangement of claim 15, wherein the mirror comprises an aspheric mirror of a head up display in a motor vehicle.

17. The arrangement of claim 15, wherein the electro-magnets are positioned relative to the mirror magnet such that the electro-magnets can be individually activated to thereby attract the mirror magnet and thereby cause rotation of the mirror about the axis.

18. The arrangement of claim 15, wherein the electro-magnets can be individually activated by applying a respective voltage to each said electro-magnet.

19. The arrangement of claim 15, wherein at least a portion of the arcuate pattern in which the electro-magnets are positioned is disposed directly above the mirror magnet.

20. The arrangement of claim 15, wherein the arcuate pattern defines a radius, the axis being at an end of the radius.

21. The arrangement of claim 15, wherein the mirror magnet is attached to a longitudinal end of the mirror.
